(19) United States
(12) Patent Application Publication
(10) Pub. No.: US 2020/0051196 A1
(43) Pub. Date: Feb. 13, 2020

(54) SYSTEMS AND METHODS FOR IDENTIFYING DRUNK REQUESTERS IN AN ONLINE TO OFFLINE SERVICE PLATFORM

(71) Applicant: BEIJING DIDI INFINITY TECHNOLOGY AND DEVELOPMENT CO., LTD., Beijing (CN)

(72) Inventors: Yingying MIAO, Beijing (CN); Zhilong WANG, Tianjin (CN); Shaohui SHI, Hangzhou (CN)

(73) Assignee: BEIJING DIDI INFINITY TECHNOLOGY AND DEVELOPMENT CO., LTD., Beijing (CN)

(21) Appl. No.: 16/235,166

(22) Filed: Dec. 28, 2018

Related U.S. Application Data
(63) Continuation of application No. PCT/CN2018/099890, filed on Aug. 10, 2018.

(51) Int. Cl. G06Q 50/30; G06N 7/00; G06Q 10/06; G10L 25/63; G10L 15/22; G10L 15/08; G06K 9/00

(52) U.S. Cl. CPC G06Q 50/30; G06N 7/005; G06Q 10/067; G10L 25/63; G10L 2015/088; G10L 15/08; G06K 9/00335; G06K 9/00268; G10L 15/22

(57) ABSTRACT

A method for detecting drunk requesters in an O2O service platform is provided. The method may include obtaining information related to a request of an O2O service initiated by a requester. The method may also include determining a probability that the requester has consumed alcohol using an alcohol consumption prediction model based on the information related to the request, and determining whether the probability is greater than a threshold. In response to a determination that the probability is greater than the threshold, the method may further include obtaining information related to the requester, and determining whether the requester has consumed alcohol based on the information related to the requester. In response to a determination that the requester has consumed alcohol, the method may further include transmitting a notification that the requester has consumed alcohol to a provider terminal corresponding to the request of the O2O service.

### CROSS-REFERENCE TO RELATED APPLICATION

This application is a Continuation of International Application No. PCT/CN2018/099890, filed on Aug. 10, 2018, the contents of which is incorporated herein by reference.

### TECHNICAL FIELD

The present disclosure generally relates to Online to Offline (O2O) service platforms, and in specifically, to systems and methods for identifying drunk requesters in the O2O service platforms.

### BACKGROUND

With the development of Internet technology, O2O services, such as online taxi hailing services and delivery services, play a more and more significant role in people's daily lives. In some scenarios, a requester who requests for an O2O service may have consumed alcohol, which may result in a potential conflict between the requester and a provider who provides the service to the requester. Thus, it is desirable to provide effective systems and methods for detecting the drunk requesters and alerting the providers to avoid potential conflict or dispute between the requesters and providers in the O2O service platforms.

### SUMMARY

According to one aspect of the present disclosure, a system for detecting drunk requesters in an O2O service platform is provided. The system may include a data exchange port communicatively connected to a network, at least one storage medium including a set of instructions and at least one processor in communication with the data exchange port and the at least one storage medium. When executing the set of instructions, the at least one processor may be configured to direct the system to obtain information related to a request of an O2O service initiated by a requester via the data exchange port. The at least one processor may be also configured to direct the system to determine a probability that the requester has consumed alcohol using an alcohol consumption prediction model based on the information related to the request, and determine whether the probability that the requester has consumed alcohol is greater than a threshold. In response to a determination that the probability that the requester has consumed alcohol is greater than the threshold, the at least one processor may be further configured to direct the system to obtain information related to the requester, and determine whether the requester has consumed alcohol based on the information related to the requester. In response to a determination that the requester has consumed alcohol, the at least one processor is further configured to direct the system to transmit a notification that the requester has consumed alcohol to a provider terminal corresponding to the request of the O2O service via the data exchange port.

In some embodiments, the information related to the request may include at least one of a request time, a start location of the request, a location of the requester, an estimated distance between the start location of the request and the location of the requester, profile information of the requester, or historical feedback information with respect to the requester.

In some embodiments, the alcohol consumption prediction model may be generated according to a model training process. The model training process may include obtaining a plurality of historical orders. The model training process may also include obtaining a first set of historical orders with positive feedbacks and a second set of historical orders with negative feedbacks from the plurality of historical orders. The model training process may further include obtaining a preliminary model, and generating the alcohol consumption prediction model by training the preliminary model using the first set of historical orders with positive feedbacks and the second set of historical orders with negative feedbacks.

In some embodiments, the preliminary model may be at least one of a Gradient Boosting Decision Tree (GBDT) model or an Extreme Gradient Boosting (XGBoost) model.

In some embodiments, to obtain information related to the requester, the at least one processor may be further configured to direct the system to transmit a request to turn on a camera of a requester terminal associated with the requester via the data exchange port. Upon receiving an approval of the request from the requester, the at least one processor may be further configured to direct the system to transmit a command via the data exchange port to the requester terminal to record at least one image or video, and receive the at least one image or video from the requester terminal via the data exchange port.

In some embodiments, to obtain the information related to the requester, the at least one processor may be further configured to direct the system to transmit a request to obtain an audio of the requester to at least one of a requester terminal or a provide terminal via the data exchange port. The request may cause the at least one of the requester terminal or the provider terminal to activate the audio recording in the at least one of the requester terminal or the provider terminal. The at least one processor may also be configured to direct the system to and receive a recorded audio from the at least one of the requester terminal or the provider terminal via the data exchange port.

In some embodiments, the information related to the requester may include at least one of an image, a video, an audio, physiological information, or behavior information of the requester.

In some embodiments, to determine whether the requester has consumed alcohol based on the information related to the requester, the at least one processor may be further configured to direct the system to perform at least one of analyzing acoustic properties of speech of the requester based on an audio or a video of the requester; analyzing facial features of the requester based on an image or the video of the requester; analyzing body movements of the requester based on behavior information related to the requester; or analyzing physiological parameters of the requester based on physiological information of the requester.

In some embodiments, to analyze acoustic properties of speech of the requester, the at least one processor may be further configured to direct the system to perform at least one of determining a voice rate based on the audio or the video of the requester; determining a voice tone based on the audio or the video of the requester; determining a number of pauses in the audio or the video of the requester; obtaining one or more keywords from the audio or the video of the requester; determining durations of sentences spoken by the requester in the audio or the video of the requester; determining a frequency of misarticulations in the audio or the video of the requester; determining a Linear Prediction Coefficient (LPC) based on the audio or the video of the requester; or determining a Mel-scale Frequency Cepstral Coefficient (MFCC) based on the audio or the video of the requester.

In some embodiments, to analyze facial features of the requester based on an image or a video of the requester, the at least one processor may be further configured to direct the system to perform at least one of determining colors of at least one of the face or the neck of the requester; determining pupil sizes of the requester; determining a blinking frequency of the requester; determining a nodding frequency of the requester; determining a yawning frequency of the requester; or determining an eye closure duration of the requester.

In some embodiments, to analyze body movements of the requester based on behavior information related to the requester, the at least one processor may be further configured to direct the system to perform at least one of determining whether the torso of the requester wobbles unsteadily; or determining whether at least one leg of the requester wobbles unsteadily; or determining whether at least one arm of the requester wobbles unsteadily.

In some embodiments, to analyze physiological parameters of the requester based on the physiological information of the requester, the at least one processor may be further configured to direct the system to perform at least one of obtaining a blood sugar level of the requester based on the physiological information of the requester; obtaining a blood pressure of the requester based on the physiological information of the requester; obtaining a breathing rate of the requester based on the physiological information of the requester; obtaining a body temperature of the requester based on the physiological information of the requester; or obtaining a heart rate of the requester based on the physiological information of the requester.

According to another aspect of the present disclosure, a method implemented on a computing device is provided. The computing device may have at least one processor, at least one computer-readable storage medium, and a communication platform connected to a network. The method may include obtaining information related to a request of an O2O service initiated by a requester via a data exchange port. The method may also include determining a probability that the requester has consumed alcohol using an alcohol consumption prediction model based on the information related to the request, and determining whether the probability that the requester has consumed alcohol is greater than a threshold. In response to a determination that the probability that the requester has consumed alcohol is greater than the threshold, the method may further include obtaining information related to the requester, and determining whether the requester has consumed alcohol based on the information related to the requester. In response to a determination that the requester has consumed alcohol, the method may further include transmitting a notification that the requester has consumed alcohol to a provider terminal corresponding to the request of the O2O service via the data exchange port.

According to another aspect of the present disclosure, a non-transitory computer-readable storage medium embodying a computer program product. The computer program product including instructions may be configured to cause a computing device to obtain information related to a request of an O2O service initiated by a requester via the data exchange port. The computer program product including instructions may be configured to cause the computing device to determine a probability that the requester has consumed alcohol using an alcohol consumption prediction model based on the information related to the request, and determine whether the probability that the requester has consumed alcohol is greater than a threshold. In response to a determination that the probability that the requester has consumed alcohol is greater than the threshold, the computer program product including instructions may be further configured to cause the computing device to obtain information related to the requester, and determine whether the requester has consumed alcohol based on the information related to the requester. In response to a determination that the requester has consumed alcohol, the computer program product including instructions may be configured to cause the computing device to transmit a notification that the requester has consumed alcohol to a provider terminal corresponding to the request of the O2O service via the data exchange port.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary O2O service system according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device on which a terminal may be implemented according to some embodiments of the present disclosure;

FIG. 4A and 4B are block diagrams illustrating exemplary processing engines according to some embodiments of the present disclosure;

FIG. 5 is a flowchart illustrating an exemplary process for determining whether a requester of an O2O service has consumed alcohol according to some embodiments of the present disclosure;

FIG. 6 is a flowchart illustrating an exemplary process for generating an alcohol consumption prediction model according to some embodiments of the present disclosure; and

FIG. 7 is a flowchart illustrating an exemplary process for determining whether a requester has consumed alcohol based on information related to the requester according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Embodiments of the present disclosure may be applied to different transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express.

The application scenarios of different embodiments of the present disclosure may include but not limited to one or more webpages, browser plugins and/or extensions, client terminals, custom systems, intracompany analysis systems, artificial intelligence robots, or the like, or any combination thereof. It should be understood that application scenarios of the system and method disclosed herein are only some examples or embodiments. Those having ordinary skills in the art, without further creative efforts, may apply these drawings to other application scenarios. For example, other similar server.

The term “passenger,” “requester,” “requestor,” “service requester,” “service requestor” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a requester, a passenger, a driver, an operator, or the like, or any combination thereof. In the present disclosure, “requester” and “requester terminal” may be used interchangeably, and “provider” and “provider terminal” may be used interchangeably.

The term “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The present disclosure provides systems and methods for detecting drunk requesters and alerting the providers to avoid potential conflict and dispute between the requesters and providers in the O2O service platform. After receiving a request for an O2O service from a requester, the systems and methods may obtain information related to the request, which may provide an indication of whether the requester has consumed alcohol. The information related to the request may include for example, a request time, location information related to the request, profile information of the requester, or historical feedback information with respect to the requester, or the like, or any combination thereof. The systems and methods may determine a probability whether the requester has consumed alcohol based on the information related to the request and an alcohol consumption prediction model. The systems and methods may also determine whether the probability is greater than a threshold. If the probability is greater than the threshold, the systems and methods may further determine whether the requester has consumed alcohol based on real-time information of the requester, such as an image, a video, behavior information, and/or physiological information of the requester. Upon a determination that the requester has consumed alcohol, the systems and methods may transmit a notification regarding the drunk requester to a provider terminal of the corresponding provider to prevent a potential conflict between the provider and the requester.

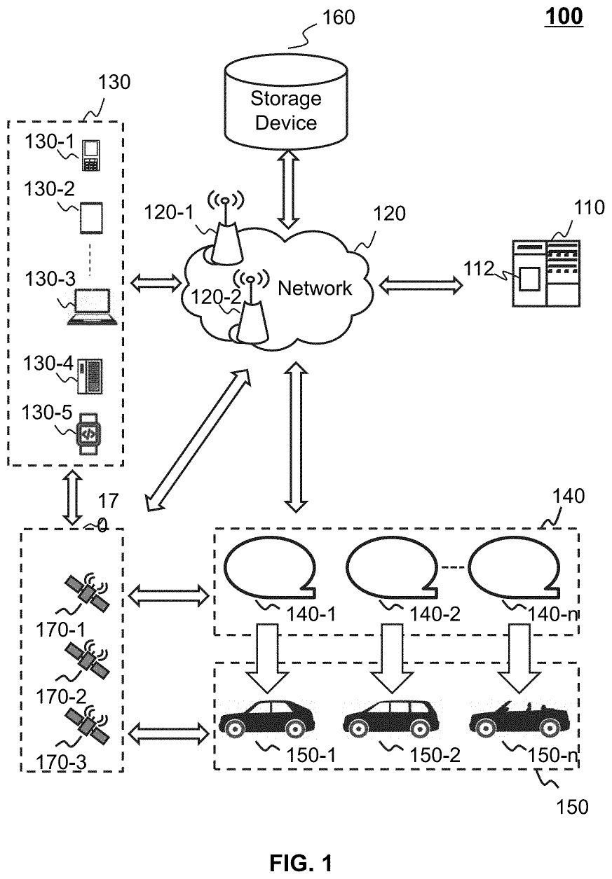

FIG. 1 is a block diagram illustrating an exemplary O2O service system 100 according to some embodiments of the present disclosure. For example, the O2O service system 100 may be an online transportation service platform for transportation services. The O2O service system 100 may include a server 110, a network 120, a requester terminal 130, a provider terminal 140, a vehicle 150, a storage device 160, and a navigation system 170.

The O2O service system 100 may provide a plurality of services. Exemplary service may include a taxi-hailing service, a chauffeur service, an express car service, a carpool service, a bus service, a driver hire service, and a shuttle service. In some embodiments, the O2O service may be any online service, such as booking a meal, shopping, or the like, or any combination thereof.

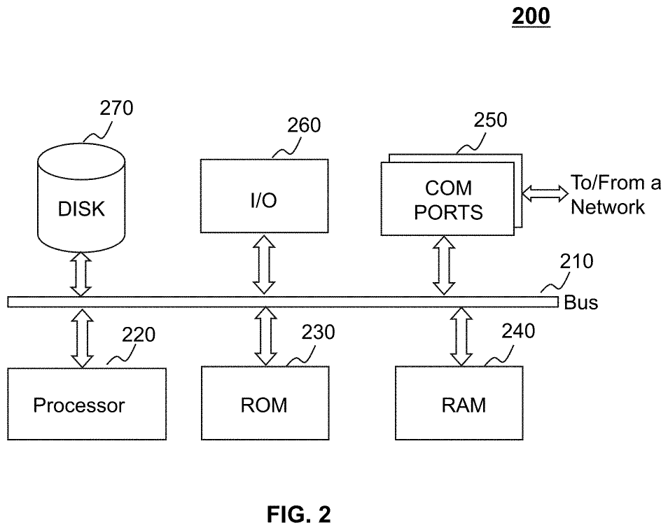

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 160 via the network 120. As another example, the server 110 may be directly connected to the requester terminal 130, the provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may analyze information of a request of an O2O service initiated by a requester and/or information of the requester to determine whether the requester has consumed alcohol. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the requester terminal 130, the provider terminal 140, the vehicle 150, the storage device 160, and the navigation system 170) may transmit information and/or data to other component(s) of the O2O service system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the O2O service system 100 may be connected to the network 120 to exchange data and/or information.

In some embodiments, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably. In some embodiments, the provider terminal may be associated with one or more service providers (e.g., a night-shift service provider, or a day-shift service provider).

In some embodiments, the requester terminal 130 may include a mobile device 130-1, a tablet computer 130-2, a laptop computer 130-3, a built-in device in a vehicle 130-4, a wearable device 130-5, or the like, or any combination thereof. In some embodiments, the mobile device 130-1 may include a smart home device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift, a HoloLens, a Gear VR, etc. In some embodiments, the built-in device in the vehicle 130-4 may include an onboard computer, an onboard television, etc. In some embodiments, the requester terminal 130 may be a device with positioning technology for locating the position of the passenger and/or the requester terminal 130. In some embodiments, the wearable device 130-5 may include a smart bracelet, a smart footgear, smart glasses, a smart helmet, a smart watch, smart clothing, a smart backpack, a smart accessory, or the like, or any combination thereof. In some embodiments, the wearable device 130-5 may include one or more sensors that can measure and collect physiological data of a wearer (e.g., a service requester wearing the wearable device 130-5). The physiological data may be used to determine whether the wearer has consume alcohol.

The provider terminal 140 may include a plurality of provider terminals 140-1, 140-2, . . . , 140-n. In some embodiments, the provider terminal 140 may be similar to, or the same device as the requester terminal 130. In some embodiments, the provider terminal 140 may be customized to be able to implement the on-demand transportation service 100. In some embodiments, the provider terminal 140 may be a device with positioning technology for locating the service provider, the provider terminal 140, and/or a vehicle 150 associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether a vehicle 150 associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the on-demand transportation service 100.

In some embodiments, the provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service).

The storage device 160 may store data and/or instructions. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. In some embodiments, storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the requester terminal 130, or the provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the requester terminal 130, the provider terminal 140). In some embodiments, the storage device 160 may be part of the server 110.

The navigation system 170 may determine information associated with an object, for example, one or more of the requester terminal 130, the provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may transmit the information mentioned above to the network 120, the requester terminal 130, the provider terminal 140, or the vehicle 150 via wireless connections.

In some embodiments, one or more components of the O2O service system 100 (e.g., the server 110, the requester terminal 130, the provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 130 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 illustrates a schematic diagram of an exemplary computing device according to some embodiments of the present disclosure. The computing device may be a computer, such as the server 110 in FIG. 1 and/or a computer with specific functions, configured to implement any particular system according to some embodiments of the present disclosure. Computing device 200 may be configured to implement any components that perform one or more functions disclosed in the present disclosure. For example, the server 110 may be implemented in hardware devices, software programs, firmware, or any combination thereof of a computer like computing device 200. For brevity, FIG. 2 depicts only one computing device. In some embodiments, the functions of the computing device may be implemented by a group of similar platforms in a distributed mode to disperse the processing load of the system.

The computing device 200 may include a communication terminal 250 that may connect with a network that may implement the data communication. The computing device 200 may also include a processor 220 that is configured to execute instructions and includes one or more processors. The schematic computer platform may include an internal communication bus 210, different types of program storage units and data storage units (e.g., a hard disk 270, a read-only memory (ROM) 230, a random-access memory (RAM) 240), various data files applicable to computer processing and/or communication, and some program instructions executed possibly by the processor 220. The computing device 200 may also include an I/O device 260 that may support the input and output of data flows between computing device 200 and other components. Moreover, the computing device 200 may receive programs and data via the communication network.

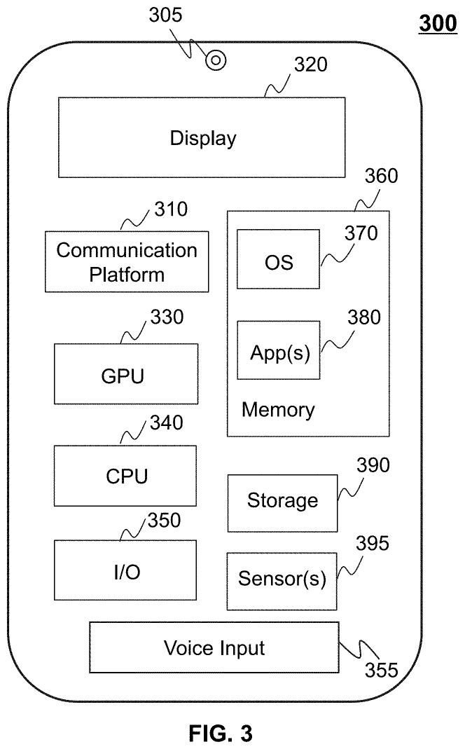

FIG. 3 is a schematic diagram illustrating exemplary hardware and/or software components of an exemplary mobile device on which a terminal may be implemented according to some embodiments of the present disclosure. As illustrated in FIG. 3, the mobile device 300 may include a camera 305, a communication platform 310, a display 320, a graphic processing unit (GPU) 330, a central processing unit (CPU) 340, an I/O 350, a voice input 355, a memory 360, a mobile operating system (OS) 370, application (s), a storage 390, and one or more sensors 395. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the O2O service system 100. User interactions with the information stream may be achieved via the I/O 350 and provided to the database 130, the server 105 and/or other components of the O2O service system 100. The camera 305 may be configured to take an image or record a video. In some embodiments, the camera 305 may be activated upon detecting a user instruction inputted from the I/O 350 or the voice input 355 of the mobile device 300. Alternatively or additionally, the camera 305 may be activated upon detecting a command from the server 110 via a data exchange port (e.g., the communication platform 310). The voice input 355 may be configured to record a voice. In some embodiments, the voice input 355 may record a speech or an audio of a user of the mobile device 300. The sensor(s) 395 may include a sensor configured to detect the movement of the mobile device 300, such as an acceleration sensor, a gyroscope, a positioning sensor, or the like, or any combination thereof. Additionally or alternatively, the sensor(s) 395 may include a sensor configured to collect physiological information of a user holding the mobile device 300. For example, the sensor(s) 395 may include a heart rate sensor, a temperature sensor, or the like, or any combination thereof. In some embodiments, the mobile device 300 may be an exemplary embodiment corresponding to the requester terminal 130 or the provider terminal 140.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

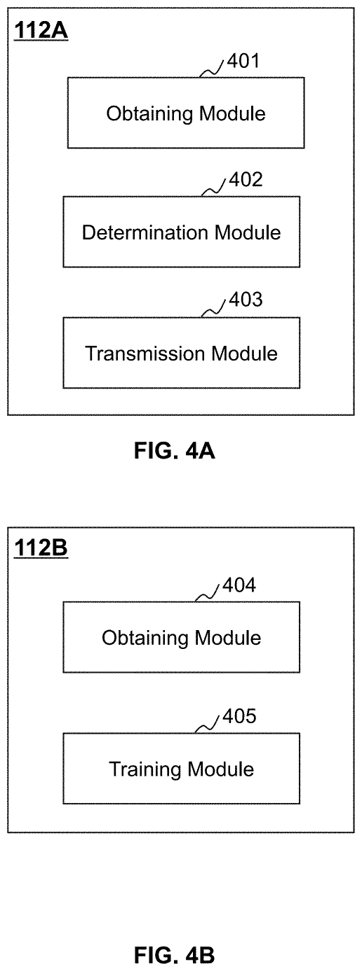

FIGS. 4A and 4B are block diagrams illustrating exemplary processing engines 112A and 112B according to some embodiments of the present disclosure. In some embodiments, the processing engines 112A and 112B may be embodiments of the processing engine 112 as described in connection with FIG. 1.

In some embodiments, the processing engine 112A may be configured to determine whether a requester has consumed alcohol based on information related to the requester and the request made by the requester. The processing engine 112B may be configured to generate an alcohol consumption prediction model. In some embodiments, the processing engines 112A and 112B may respectively be implemented on a computing device 200 (e.g., the processor 220) illustrated in FIG. 2 or a CPU 340 as illustrated in FIG. 3. Merely by way of example, the processing engine 112A may be implemented on a CPU 340 of a mobile device and the processing engine 112B may be implemented on a computing device 200. Alternatively, the processing engines 112A and 112B may be implemented on the same computing device 200 or the same CPU 340.

The processing engine 112A may include an obtaining module 401, a determination module 402, and a transmission module 403.

The obtaining module 401 may be configured to obtain information related to one or more components of the O2O service system 100. For example, the obtaining module 401 may obtain information related to a request of an O2O service initiated by a requester. Exemplary information related to the request may include time information of the request, location information of the request, profile information of the requester and/or a provider who accepts the request, or feedback information related to the requester and/or the provider. As another example, the obtaining module 401 may information related to the requester that indicates a physiological status of the requester. Exemplary information related to the requester may include an image, a video, an audio, physiological information, behavior information of the requester, or the like, or any combination thereof. In some embodiments, the obtaining module 401 may obtain information from one or more components in the O2O service system 100, for example, such as a storage device (e.g., the storage device 160), or one or more user terminals (e.g., the service requester terminal 130, the service provider terminal 140). Additionally or alternatively, the obtaining module 401 may obtain information from an external source via the network 120. For example, the obtaining module 401 may obtain the profile information of the requester (e.g., a traffic violation record of the requester) from third-party applications (e.g., a website or database of traffic violation records).

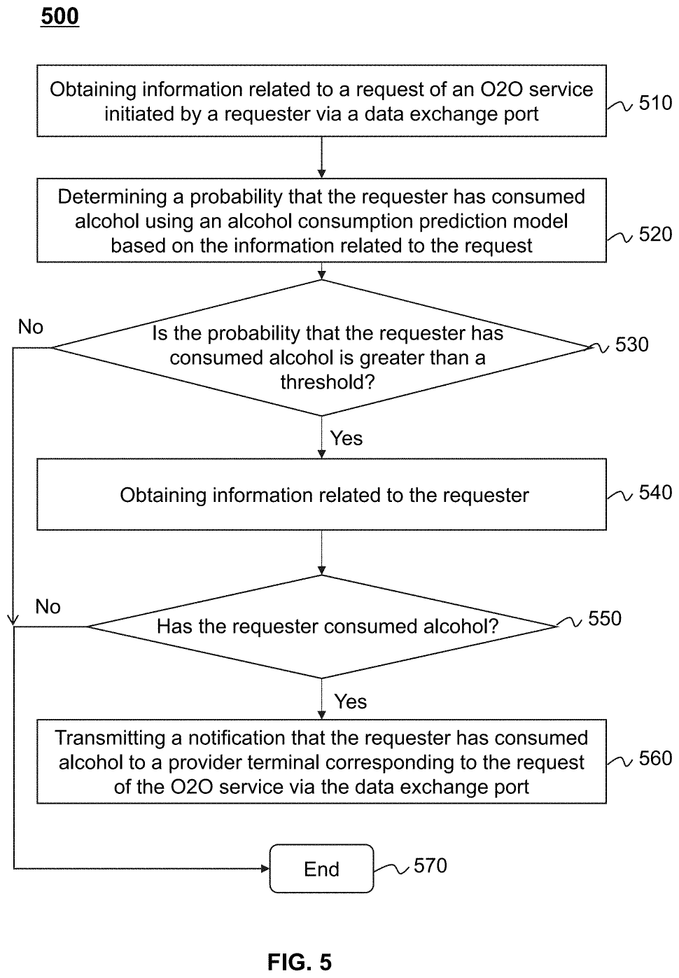

The determination module 402 may be configured to determine a probability that the requester has consumed alcohol based on an alcohol consumption prediction model and the information related to the request. In some embodiments, the information related to the request may be inputted into the alcohol consumption prediction model. The alcohol consumption prediction model may analyze the information related to the request and generate a predicted output that indicates whether the requester has consumed alcohol. In some embodiments, the predicted output may be a predicted probability that the requester has consumed alcohol. Alternatively, the predicted output may be a predicted category regarding whether the requester has consumed alcohol. The processing engine 112A may further determine the probability based on the predicted category. In some embodiments, the determination module 402 may be further configured to determine whether the probability that the requester has consumed alcohol is greater than a threshold. More descriptions regarding the determination of the probability that the requester has consumed alcohol may be found elsewhere in the present disclosure. See, e.g., operations 520 and 530 in FIG. 5 and the relevant descriptions thereof.

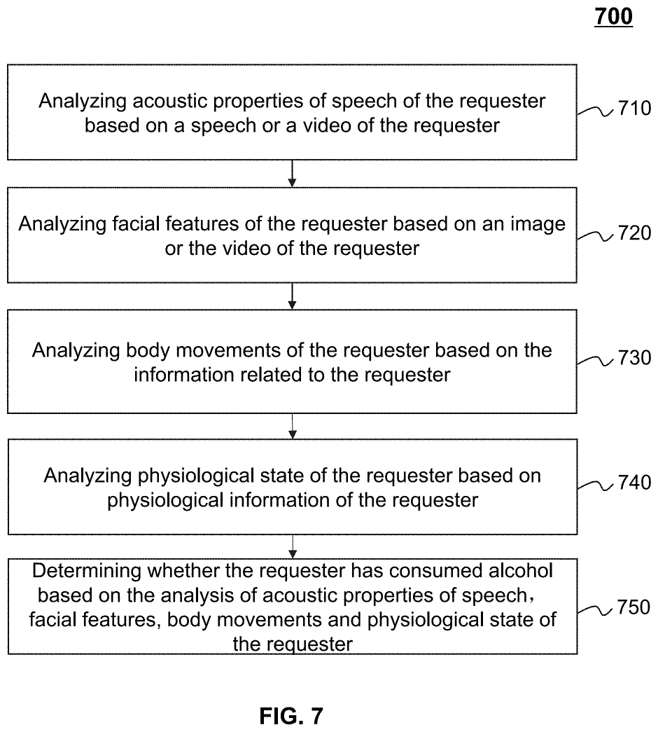

In some embodiments, the determination module 402 may be configured to determine that the requester has consumed alcohol based on the information related to the requester (e.g., an image, an audio, or a video of the requester). In some embodiments, the determination module 402 may analyze one or more features of the requester based on the information related to the requester, and determine whether the requester has consumed alcohol based on the analysis result. Details regarding the determination as to whether the requester has consumed alcohol may be found elsewhere in the present disclosure. See, e.g., FIG. 7 and the relevant descriptions thereof.

The transmission module 403 may be configured to transmit a notification that the requester has consumed alcohol to a provider terminal of the provider who accepts the request. The notification may alert the provider that the requester has consumed alcohol, which may prevent a potential conflict between the provider and the requester. In some embodiments, the notification may be any form, such as a text, an image, a voice, a video, or a combination thereof.

The processing engine 112B may include an obtaining module 404 and a training module 405.

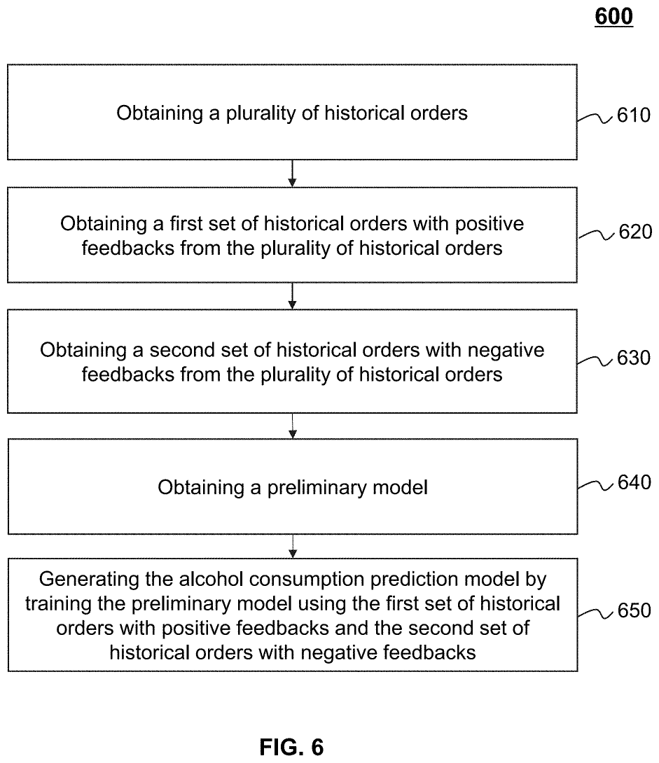

The obtaining module 404 may be configured to obtain information used to train an alcohol consumption prediction model. For example, the obtaining module 404 may obtain historical order information related to a plurality of historical orders. For example, the historical order information may include historical information related to the corresponding historical request and/or historical feedback information with respect to the corresponding historical requester. In some embodiments, the historical order information related to a historical order may be expressed as a feature vector that includes one or more features of the historical order and historical value(s) of the feature(s). Details regarding the historical order information related to the plurality of historical orders may be found elsewhere in the present disclosure. See, e.g., operation 610 in FIG. 6 and the relevant descriptions thereof.

The obtaining module 404 may be further configured to obtain a first set of historical orders with positive feedbacks and a second set of historical orders with negative feedbacks from the plurality of historical orders. In some embodiments, a historical order may have a negative feedback if the historical requester of the historical order was reported to have consume alcohol. A historical order may have a positive feedback if the historical requester of the historical order was reported to have not consume alcohol. Additionally or alternatively, a historical order may have a positive feedback if the historical requester of the historical order was not reported to have consumed alcohol. The obtaining module 404 may select one or more historical orders with positive feedbacks from the historical orders, and designate them as the first set of historical orders. The obtaining module 404 may select one or more historical orders with negative feedbacks from the historical orders, and designate them as the second set of historical orders.

The training module 405 may be configured to train a model. For example, the training module 405 may obtain a preliminary model using the first set of historical orders and the second set of historical orders to generate the alcohol consumption prediction model. Details regarding the generation of the alcohol consumption prediction model may be found elsewhere in the present disclosure. See, e.g., operation 650 in FIG. 6 and the relevant descriptions thereof).

The modules may be hardware circuits of all or part of the processing engine 112. The modules may also be implemented as an application or set of instructions read and executed by the processing engine 112A or 112B. Further, the modules may be any combination of the hardware circuits and the application/instructions. For example, the modules may be the part of the processing engine 112A when the processing engine 112A or 112B is executing the application/set of instructions.

It should be noted that the above description of the processing engine 112 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, any module mentioned above may be implemented in two or more separate units. For example, the functions of determination module 402 may be implemented in two separate units, one of which is configured to determine the probability that the requester has consumed alcohol based on the information related to the request, and the other is configured to determine whether the requester as consumed alcohol based on the information related to the requester. In some embodiments, the processing engine 112A and/or the processing engine 112B may further include one or more additional modules (e.g., a storage module). In some embodiments, the processing engines 112A and 112B may be integrated as one processing engine.

FIG. 5 is a flowchart illustrating an exemplary process for determining whether a requester of an O2O service has consumed alcohol according to some embodiments of the present disclosure. At least a portion of process 500 may be implemented on the computing device 200 as illustrated in FIG. 2 or the mobile device 300 as illustrated in FIG. 3. In some embodiments, one or more operations of process 500 may be implemented in the O2O service system 100 as illustrated in FIG. 1. In some embodiments, one or more operations in the process 500 may be stored in a storage device (e.g., the storage device 160, the ROM 230, the RAM 240, the storage 390.) as a form of instructions, and invoked and/or executed by the server 110 (e.g., the processing engine 112A in the server 110, or the processor 220 of the computing device 200). In some embodiments, the instructions may be transmitted in a form of electronic current or electrical signals.

In 510, the processing engine 112A (e.g., the obtaining module 401) may obtain information related to a request of an O2O service initiated by a requester via a data exchange port.

Exemplary O2O services may include a taxi-hailing service, a chauffeur service, an express car service, a carpool service, a bus service, a driver-for-hire service, a shuttle service, a take-out service, or the like, or any combination thereof. In some embodiments, the O2O service may be any online service, such as a meal booking service, an online shopping service, or the like, or any combination thereof. In some embodiments, the request of the O2O service may be sent by the requester via a requester terminal 130, for example, via an application for O2O service installed in the requester terminal 130.

The information related to the request of the O2O service may include any information related to the request and/or the requester. For example, the information may include a request time, a start location of the request, a location of the requester, a destination, an estimated distance (e.g., a linear distance or a route distance) between the start location and the location of the requester, an estimated distance (e.g., a linear distance or a route distance) between the start location and the destination, profile information of the requester, historical feedback information with respect to the requester, or the like, or any combination thereof. In some embodiments, the information may include at least one of the request time, the start location of the request, the location of the requester, the estimated distance between the start location of the request and the location of the requester, the profile information of the requester, or the historical feedback information with respect to the requester.

The request time may refer to a time point when the requester initiates the request of an O2O service or an appointment time point when the requester wants to receive the O2O service. The start location of the request may refer to a location where the requester wants to receive the O2O service. The location of the requester may refer to the location where the requester initiates the request. In some embodiments, the start location of the request and the location of the requester may be the same or different. The destination may refer to a location where the requester wants to complete the O2O service. The profile information of the requester may include the gender, the age, contact information (e.g., telephone number), an education level, an address, an occupation, a marriage state, a criminal record, a credit record, a traffic violation record, or the like, or any combination thereof. The historical feedback information with respect to the requester may include a performance score of the requester evaluated by service providers, a comment and/or complaint with respect to the requester, the number of times that the requester was reported for improper conduct (e.g., consuming alcohol). In some embodiments, the historical feedback information may be within a predetermined time period, for example, last month, last half of a year, or last year before the request time of the request.

In some embodiments, the information related to the request may be used to evaluate whether requester has consumed alcohol to some extent. For example, a requester who initiates a request at night is more likely to drink alcohol. As another example, a requester who initiates a request near a bar is more likely to drink alcohol. Therefore, the information related to the request may be used to estimate the probability that the requester has consumed alcohol.

In some embodiments, the information related to the request may be obtained from one or more components of the O2O service system 100. Merely by way of example, a portion of the profile information may be inputted by the requester and stored in the storage device 160. The obtaining module 401 may retrieve the portion of the profile information from the storage device 160 via the data exchange port. Additionally or alternatively, the information related to the request may be obtain from an external source via the network 120 and the data exchange port. In some embodiments, the profile information of the requester may be obtained from one or more third-party applications that share the user information with each other. For example, the traffic violation record of the requester may be obtained from a website or database of traffic violation records.

The data exchange port may establish a connection between the processing engine 112A and one or more other components in the O2O service system 100, such as the terminal device 130 of the requester, the storage device 160. The connection may be a wired connection, a wireless connection, any other communication connection that can enable data transmission and/or reception, and/or any combination of these connections. In some embodiments, the data exchange port may be similar to the COM 250 described in FIG. 2, and the descriptions thereof are not repeated here.

In 520, the processing engine 112A (e.g., the determination module 402) may determine a probability that the requester has consumed alcohol using an alcohol consumption prediction model based on the information related to the request. For brevity, the probability that the requester has consumed alcohol may be referred to as the probability.

In some embodiment, the information related to the request may be inputted into the alcohol consumption prediction model. The alcohol consumption prediction model may analyze the information related to the request and generate a predicted output that indicates whether the requester has consumed alcohol. In some embodiments, the predicted output may be a predicted probability that the requester has consumed alcohol. Alternatively, the predicted output may be a predicted category regarding whether the requester has consumed alcohol. The processing engine 112A may further determine the probability based on the predicted category. For example, the predicted category may include a first category that the requester has consumed alcohol and a second category that the requester has not consumed alcohol. The processing engine 112A may determine a first probability value indicating that a requester belongs to the first category and a second probability value indicating that a requester belongs to the second category. The first probability value may be higher than the second probability value. Merely by way of example, the first probability value may be 1 and the second probability value may be 0. As another example, the first probability value may be 0.7 and the second probability value may be 0.3.

In some embodiments, the alcohol consumption prediction model may be generated by training a preliminary model using a plurality of historical orders. The preliminary model may include a machine learning model, such as but not limited to a Gradient Boosting Decision Tree (GBDT) model or an Extreme Gradient Boosting (XGBoost) model. Details regarding the alcohol consumption prediction model may be found elsewhere in the present disclosure, for example, FIG. 6 and the descriptions thereof.

In some embodiments, the probability may be expressed in various forms. For example, the probability may be expressed as a percentage (e.g., a value between 0 and 100%). A greater percentage may indicate a higher probability that the requester has consumed alcohol. As another example, the probability may be expressed as a score (e.g., a value between 0 and 10). A greater score may indicate a higher probability that the requester has consumed alcohol.

In 530, the processing engine 112A (e.g., the determination module 402) may determine whether the probability that the requester has consumed alcohol is greater than a threshold. In response to a determination that the probability is greater than the threshold, the process 500 may proceed to 540. In response to a determination that the probability is not greater than the threshold, the process 500 may proceed to 570.

The threshold may be any positive value. The threshold may vary according to the expression form of the probability. For example, if the probability is expressed as a percentage between 0 and 100%, the threshold may be, for example, 50%, 60%, 70%, 80%, 90%, or any other positive percentage. As another example, if the probability is expressed as a value between 0 and 10, the threshold may be, for example, 5, 6, 7, 8, 9, or any other positive value between 0 and 10. In some embodiments, the threshold may be a value equal to or greater than the median of the probability range.

In some embodiments, the threshold may be a default setting stored in a storage device (e.g., the storage device 160) or be set by a user of the O2O service system 100 via a terminal. In some embodiments, the threshold may be determined or adjusted by one or more component of the O2O service system 100 (e.g., the processing engine 112A) according different situations. For example, a threshold with respect to a request in daytime may be higher than that with respect to a request at night, considering a requester is more likely to drink alcohol at night.

In 540, the processing engine 112A (e.g., the obtaining module 401) may obtain information related to the requester. The information related to the requester may include any real-time information indicating a physiological status of the requester. Exemplary information related to the requester may include an image, a video, an audio, physiological information, behavior information of the requester, or the like, or any combination thereof.

In some embodiments, the image and/or the video of the requester may be obtained from a requester terminal 130 of the requester. In some embodiments, to obtain the image and/or the video of the requester, the processing engine 112A may transmit a request to turn on a camera of the requester terminal 130 via the data exchange port. Upon receiving an approval of the request from the requester, the processing engine 112A may transmit a command via the data exchange port to the requester terminal 130 to record the image and/or video of the requester. The processing engine 112A may further receive the image and/or video from the requester terminal 130 via the data exchange port.

In some embodiments, the audio of the requester may include a period of audio sent by the requester to a provider who accepts the request. Additionally or alternatively, the audio of the requester may include a period of audio recording a conversation between the requester and the provider. The audio of the requester may be obtained from the requester terminal 130 of the requester and/or a provider terminal 140 of the provider who accepts the request. In some embodiments, the processing engine 112A may transmit a request to obtain the audio to at least one of the requester terminal 130 or the provider terminal 140 via the data exchange port. The request may cause at least one of the requester terminal 130 or the provider terminal 140 to activate the audio recording. The processing engine 112A may then receive a recorded audio from the at least one of the requester terminal 130 or the provider terminal 140 via the data exchange port.

The physiological information may include a blood sugar level, a blood pressure, a breathing rate, a body temperature, a heart rate of requester, or the like, or any combination thereof. In some embodiments, the physiological information of the requester may be obtained from a wearable device (e.g., a wearable device 130-5) worn by the requester and/or one or more sensors 395 of the requester terminal 130.

The behavior information may include a body movement (e.g., a body wobbling, a leg wobbling, and/or an arm wobbling), a walking speed of the requester, or the like, or any combination thereof. In some embodiments, the behavior information may be obtained from one or more images and/or videos of the requester by the processing engine 112A. For example, the processing engine 112A may detect a body wobbling, a leg wobbling, and/or an arm wobbling by analyzing the image(s) and/or video(s) of the requester. Additionally or alternatively, the behavior information may be obtained from the requester terminal 130. For example, the requester terminal 130 may be configured with one or more sensors 395, such as an acceleration sensor or a gyroscope that can detect the movement of the requester terminal 130, which in turn, may reflect the movement of the requester.

In 550, the processing engine 112A (e.g., the determination module 402) may determine whether the requester has consumed alcohol based on the information related to the requester. In response to a determination that requester has consumed alcohol, the process 500 may proceed to 560. In response to a determination that the requester has not consumed alcohol, the process 500 may proceed to 570.

In some embodiments, the determination module 402 may analyze one or more features of the requester based on the information related to the requester. The determination module 402 may further determine whether the requester has consumed alcohol based on the analysis result. The one or more features may include an acoustic feature, a facial features, a body movement, a physiological parameter of the requester, or the like, or any combination thereof. Details of the determination as to whether the requester has consumed alcohol may be found elsewhere in the present disclosure, for example, FIG. 7 and the descriptions thereof.

In 560, the processing engine 112A (e.g., the transmission module 403) may transmit a notification that the requester has consumed alcohol to a provider terminal 140 corresponding to the request of the O2O service via the data exchange port.

The provider terminal 140 corresponding to the request may refer to a provider terminal 140 of the provider who accepts the request. In some embodiments, the notification may be in any form, such as a text, an image, a voice, a video, or a combination thereof. The notification alerts the provider of the O2O service that the requester has consumed alcohol, which may prevent a potential conflict between the provider and the requester.

In 570, the processing engine 112A may end the process 500.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, after operation 560 or 570, the processing engine 112A may transmit an inquiry to the provider terminal 140 corresponding to the request to confirm whether the requester has consumed alcohol. In some embodiments, the processing engine 112A may utilize the inquiry result in the training and/or updating of the alcohol consumption prediction model.

FIG. 6 is a flowchart illustrating an exemplary process for generating an alcohol consumption prediction model according to some embodiments of the present disclosure. At least a portion of process 600 may be implemented on the computing device 200 as illustrated in FIG. 2 or the mobile device 300 as illustrated in FIG. 3. In some embodiments, one or more operations of process 600 may be implemented in the O2O service system 100 as illustrated in FIG. 1. In some embodiments, one or more operations in the process 600 may be stored in a storage device (e.g., the storage device 160, the ROM 230, the RAM 240, the storage 390, etc.) as a form of instructions, and invoked and/or executed by the server 110 (e.g., the processing engine 112B in the server 110, or the processor 220 of the computing device 200). In some embodiments, part or all of the process 600 may be performed to achieve operation 520 as described in connection with FIG. 5.

In 610, the processing engine 112B (e.g., the obtaining module 404) may obtain a plurality of historical orders.

As used herein, “obtaining a plurality of historical orders” may refer to “obtaining historical order information related to the historical orders”. A historical order may refer to a service order that has been completed. In some embodiments, the historical orders obtained in operation 610 may be within a predetermined time period, for example, a year (e.g., last year, current year, recent one year), half of a year (e.g., recent six months, the first half of the current year), a quarter of a year (e.g., recent three months, the second quarter of current year), or the like, or any combination thereof.

The historical order information related to a historical order may include historical information related to the corresponding historical request. The historical information related to the historical request may include a historical request time, a historical start location, a historical destination, a historical location of the corresponding historical requester when he/she initiated the historical order, an estimated distance between the historical start location and the historical destination, an estimated distance between the historical start location and the historical location of the historical requester, profile information of the historical requester, historical feedback information with request to the historical requester, or the like, or any combination thereof. The historical information related to the historical request may be similar to information related to a request as described in connection with operation 510, and the descriptions thereof are not repeated here. In some embodiments, the historical order information related to the historical order may further include price information, information related to the corresponding historical provider (e.g., profile information of the historical provider, historical feedback information with respect to the historical provider), or the like, or any combination thereof.

In some embodiments, the historical order information related to the historical order may include historical feedback information with respect to the historical requester. The historical feedback information may include a feedback provided by the historical provider regarding whether the historical requester has consumed alcohol when he/she initiated the historical order. In some embodiment, if the feedback indicates that the historical requester has not consumed alcohol, it may be regarded as a positive feedback. If the feedback indicates that the historical requester has consumed alcohol, it may be regarded as a negative feedback. In some embodiments, the historical provider may not provide a feedback regarding whether the historical requester has consumed alcohol. The historical requester may be assumed to have not consumed alcohol and the historical order may have a positive feedback.

In some embodiments, the historical order information related to a historical order may be expressed as a feature vector that includes one or more features of the historical order. An N-dimensional vector may be associated with N features. In some embodiments, the processing engine 112 (e.g., the processing engine 112B) may process one or more feature vectors at once. For example, m features vectors (e.g., three-row vectors) may be integrated into a 1×mN vector or an m×N matrix, where m is an integer.

In 620, the processing engine 112B (e.g., the obtaining module 404) may obtain a first set of historical orders with positive feedbacks from the plurality of historical orders. In 630, the processing engine 112B (e.g., the obtaining module 404) may obtain a second set of historical orders with negative feedbacks from the plurality of historical orders.

As described in connection with operation 610, a historical order may have a negative feedback if the historical requester of the historical order was reported to have consume alcohol. A historical order may have a positive feedback if the historical requester of the historical order was reported to have not consume alcohol. Additionally or alternatively, a historical order may have a positive feedback if the historical requester of the historical order was not reported to have consumed alcohol. In some embodiments, the obtaining module 404 may select one or more historical orders with positive feedbacks from the historical orders, and designate them as the first set of historical orders. The obtaining module 404 may select one or more historical orders with negative feedbacks from the historical orders, and designate them as the second set of historical orders. In some embodiments, the number of historical orders in the second set may be the same as or different from that of the first set.

In 640, the processing engine 112B (e.g., the obtaining module 404) may obtain a preliminary model.

The preliminary model may include a machine learning model, such as a Gradient Boosting Decision Tree (GBDT) model, an Extreme Gradient Boosting (XGBoost) model, and a random forest model. In some embodiments, the preliminary model may have default settings (e.g., one or more preliminary parameters) of the O2O service system 100 or be adjustable in different situations. Taking a preliminary model of XGBoost model as an example, the preliminary model may include one or more preliminary parameters, such as a booster type (e.g., tree-based model or linear model), a booster parameter (e.g., a maximum depth, a maximum number of leaf nodes), a learning task parameter (e.g., an objective function of training), or the like, or any combination thereof.

In 650, the processing engine 112B (e.g., the training module 405) may generate the alcohol consumption prediction model by training the preliminary model using the first set of historical orders with positive feedbacks and the second set of historical orders with negative feedbacks. The alcohol consumption prediction model may be configured to predict whether a requester of an O2O service has consumed alcohol based on request information. In some embodiments, the prediction result may be a predicted probability that the requester has consumed alcohol or a predicted category indicating whether the requester has consumed alcohol.

In some embodiments, in the training of the preliminary model, the first set and the second set of historical orders may be regarded as having different probabilities that the historical requester has consumed alcohol. For example, the probability corresponding to a historical order in the first set with a positive feedback may be regarded as a third possibility value, and the probability corresponding to a historical order in the second set with a negative feedback may be regarded as a fourth possibility value. The third probability value may be lower than the fourth probability value. Merely by way of example, the third probability value may be 0 and the fourth probability value may be 1. As another example, the first probability value may be 0.3 and the second probability value may be 0.7. Alternatively, the first set and second set of historical orders may be regarded as two separate categories.

The training module 405 may input the feature information of each historical order in the first and second sets into the preliminary model to output a corresponding predicted probability (or predicted categories). The training module 405 may further determine a difference between the predicted probabilities and known probabilities (or between predicted categories and known categories) of the historical orders in the first and second sets. The difference may also be referred to as a loss function for brevity. According to the loss function, the training module 405 may further adjust the preliminary model (e.g., adjust the preliminary parameters) until the loss function reaches a desired value. After the loss function reaches the desired value, the adjusted preliminary binary model may be designated as the alcohol consumption prediction model.

In some embodiments, the objective function of the training of the preliminary model may include the loss function (or training loss) as well as a regularization. The loss function measures how well the preliminary model fits on training data. The regularization measures the complexity of the preliminary model. In some embodiments, if the prediction output of the alcohol consumption prediction model is a predicted probability that the requester has consumed alcohol. The objective function may be a logistic function. If the prediction output of the alcohol consumption prediction model is a predicted category regarding whether the requester has consumed alcohol. The objective function may be a softmax function.

In some embodiments, the alcohol consumption prediction model may include a plurality of weights of a plurality of features of a historical order in the first or second sets of historical orders. A weight of a feature may indicate an impact of the feature on the prediction output of the alcohol consumption prediction model. A feature with a greater weight may have a greater impact than a feature with a lower weight on the prediction output of the alcohol consumption prediction model. In some embodiments, the processing engine 112B may select one or more core features from the plurality of features based on the weights of the features. For example, the processing engine 112B may select feature(s) with top N weights as the core feature(s). N may be any positive value (e.g., 10, 20, and 30) or percentage (e.g., 10%, 20%, and 30%). The core features may be used to identify drunk requesters in the O2O service system 100. Merely by way of example, according to the alcohol consumption prediction model, the request time, the location of the requester, and the gender of the requester are core features with top 3 weights. When a new request is initiated by a requester, the processing engine 112 may determine a probability that the requester has consumed alcohol by analyzing the request time, the requester location of the requester, and the gender of the requester of the new request.

It should be noted that the above description of the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, 620 and 630 may be combined in one operation. As another example, an operation may be added after 650 to test the alcohol consumption prediction model.

FIG. 7 is a flowchart illustrating an exemplary process for determining whether a requester has consumed alcohol based on information related to the requester according to according to some embodiments of the present disclosure. At least a portion of process 700 may be implemented on the computing device 200 as illustrated in FIG. 2 or the mobile device 300 as illustrated in FIG. 3. In some embodiments, one or more operations of process 700 may be implemented in the O2O service system 100 as illustrated in FIG. 1. In some embodiments, one or more operations in the process 700 may be stored in a storage device (e.g., the storage device 160, the ROM 230, the RAM 240, the storage 390, etc.) as a form of instructions, and invoked and/or executed by the server 110 (e.g., the processing engine 112A in the server 110, or the processor 220 of the computing device 200). In some embodiments, part or all of the process 700 may be performed to achieve operation 550 as described in connection with FIG. 5.

As described in connection with operations 540, the information related to the requester may include an image, a video, an audio, physiological information, behavior information of the requester, or the like, or any combination thereof. The processing engine 112A (e.g., the determination module 402) may analyze one or more features of the requester based on the information related to the requester, and determine whether the requester has consumed alcohol based on the analysis result.

In 710, the processing engine 112A (e.g., the determination 402) may analyze acoustic properties of speech of the requester based on an audio or a video of the requester.

Exemplary acoustic properties of speech may include a voice rate, a voice tone, a number of pauses, one or more key words spoken by the requester, durations of sentences spoken by the requester, a frequency of misarticulations, a Linear Prediction Coefficient (LPC), a Mel-scale Frequency Cepstral Coefficient (MFCC), or the like, or any combination thereof. In some embodiments, the determination module 402 may obtain and analyze at least one of the voice tone, the number of pauses, the one or more key words spoken by the requester, the durations of sentences spoken by the requester, the frequency of misarticulations, the LPC, or the MFCC of the requester based on the audio or the video. In some embodiments, the determination module 402 may extract the acoustic properties of speech from audio signals that include the audio or the video of the requester according to one or more speech analysis and/or recognition techniques.

In some embodiments, the determination module 402 may determine whether the requester has consumed alcohol by comparing an acoustic property of the requester with a reference value (or range) of the acoustic property. The reference value (or range) may be a reference value (or range) of the acoustic property of normal people who have not consumed alcohol, or a reference value (or range) of the acoustic property of drunk people. Merely by way of example, the determination module 402 may determine whether the voice rate of the requester is slower than a predetermined voice rate of normal people. In response to a determination that the voice rate is slower than the predetermined voice rate, the determination module 402 may determine that the requester may has consumed alcohol. As another example, the determination module 402 may determine whether the extracted key word(s) spoken by the requester includes one or more feature words that drunk people may say, for example, “drink”, “drunk”, “alcohol”, “bar”, “pub”, “wine”, or the like, or any combination thereof. In response to a determination that the extracted key word(s) includes one or more feature words, the determination module 402 may determine that the requester has consumed alcohol. As another example, the determination module 402 may determine whether the audio includes more pauses than a normal threshold. As a drunk person may stutter, more pauses in the audio may indicate that the requester has consumed alcohol. In response to a determination that the audio includes more pauses than the normal threshold, the determination module 402 may determine that the requester may has consumed alcohol. In some embodiments, the determination module 402 may determine a possibility that the requester has consumed alcohol based one the comparison result of the acoustic property. For example, the determination module 402 may determine a higher possibility that the requester has consumed alcohol because of a higher difference between the acoustic property of the requester and its corresponding reference value (or range).

In some embodiments, the determination module 402 may extract and analyze a plurality of acoustic properties of the requester to determine whether he/she has consumed alcohol. For example, the determination module 402 may compare each acoustic property with a corresponding reference value (or range). If the requester is determined to have consumed alcohol according to the comparison result of one of the acoustic properties, the determination module 402 may determine that the requester has consumed alcohol. Alternatively, the determination module 402 may determine that the request has consumed alcohol only if the requester is determined to have consumed alcohol according to the comparison results of multiple acoustic properties (e.g., 2, 3, 4, or half of the acoustic properties). In some embodiments, the determination module 402 may determine a possibility that the requester has consumed alcohol based on the comparison results of the acoustic properties.

In 720, the processing engine 112A (e.g., the determination module 402) may analyze facial features of the requester based on an image or the video of the requester.

Exemplary facial features of the requester may include colors of the face and/or the neck of the requester, pupil sizes of the requester, a blinking frequency of the requester, a nodding frequency of the requester, a yawning frequency of the requester, an eye closure duration of the requester, or the like, or any combination thereof. In some embodiments, the determination module 402 may obtain at least one of the colors of the face and/or the neck of the requester, the pupil sizes of the requester, the blinking frequency of the requester, the nodding frequency of the requester, or the yawning frequency of the requester according to the image or the video of the requester. In some embodiments, the determination module 402 may obtain the facial feature(s) of the requester from the image or the video of the requester by one or more image processing techniques, such as but not limited to an image transformation technique, an image segmentation technique, an image filtering technique, an image motion detection technique.

In some embodiments, the determination module 402 may determine whether the requester has consumed alcohol by comparing a facial feature of the requester with a reference value (or range) of the facial feature. The reference value (or range) of the facial feature may be a reference value (or range) of the facial feature of normal people who have not consumed alcohol, or a reference value (or range) of the facial feature of drunk people. For example, the determination module 402 may determine whether the colors of the face and/or the neck include red or a variation of red (e.g., pink, ruby, carmine). In response to a determination that the colors of the face and/or the neck include red or a variation of red, the determination module 402 may determine that the requester has consumed alcohol. The determination as to whether the requester has consumed alcohol based on one or more facial features of the requester may be similar to that based on one or more acoustic properties of the requester, and the descriptions thereof are not repeated here.

In 730, the processing engine 112A (e.g., the determination module 402) may analyze body movements of the requester based on the behavior information of the requester.

In some embodiments, the determination module 402 may analyze at least one of a torso wobbling, a leg wobbling, or an arm wobbling based on the behavior information of the requester. Take the torso wobbling as an example, the determination module 402 may determine whether the torso of the requester wobbles unsteadily based on the behavior information related to the requester. As used herein, the torso of the requester may be regarded as wobbling unsteadily if the wobbling amplitude and/or the wobbling frequency of the torso of the requester exceed a predetermined value (or range). In response to a determination that the torso of the requester wobbles unsteadily, the determination module 402 may determine that the requester has consume alcohol. As another example, the determination module 402 may determine whether the requester has consumed alcohol by determining whether at least one leg (or arm) of the requester wobbles unsteadily. The determination as to whether the requester has consumed alcohol based on leg wobbling or arm wobbling may be similar to that based on torso wobbling, and the descriptions thereof are not repeated.

In some embodiments, the determination module 402 may determine that the requester has consumed alcohol if he/she is determined to have consumed alcohol according to the analysis result of at least one of the torso wobbling, the leg wobbling, or the arm wobbling. Alternative, the determination module 402 may determine that the requester has consumed alcohol if he/she is determined to have consumed alcohol according to the analysis results of at least two or all of the torso wobbling, the leg wobbling, or the arm wobbling.

In 740, the processing engine 112A (e.g., the determination module 402) may analyze physiological parameters of the requester based on physiological information of the requester.

Exemplary physiological parameters may include a blood sugar level, a blood pressure, a breathing rate, a body temperature, a heart rate of requester, or the like, or any combination thereof. In some embodiments, the determination module 402 may obtain and analyze at least one of the blood sugar level, the blood pressure, the breathing rate, the body temperature, or the heart rate of requester based on the physiological information of the requester.

In some embodiments, the determination module 402 may determine whether the requester has consumed alcohol by comparing a physiological parameter of the requester with a reference value (or range) of the physiological parameter. The reference value (or range) of the physiological parameter may be a reference value (or range) of the physiological parameter of normal people who have not consumed alcohol, or a reference value (or range) of the physiological parameter of drunk people. For example, the determination module 402 may determine whether the heart rate of the requester is greater than a predetermined heart rate of normal people. In response to a determination that the heart rate of the requester is greater than the predetermined heart rate, the determination module 402 may determine that the requester has consumed alcohol. The determination as to whether the requester has consumed alcohol based on one or more physiological parameters of the requester may be similar to that based on one or more acoustic properties of the requester, and the descriptions thereof are not repeated here.

In 750, the processing engine 112A (e.g., the determination module 402) may determine whether the requester has consumed alcohol based on the analysis of the acoustic property (or properties) of speech, the facial feature(s), the body movement(s), and the physiological parameter(s) of the requester.

In some embodiments, the determination module 402 may determine that the requester has consumed alcohol if at least one of the analysis results of the acoustic property (or properties) of speech, the facial feature(s), the body movement(s), and the physiological parameter(s) shows that the requester has consumed alcohol. Alternatively, the determination module 402 may determine that that the requester has consumed alcohol if multiple analysis results (e.g., 2, 3, or all of the analysis results) show that the requester has consumed alcohol. In some embodiments, the determination module 402 may determine a weighted possibility based on the possibilities that the requester has consumed alcohol determined by the analysis of the acoustic property (or properties), the facial feature(s), the body movement(s), and the physiological parameter(s). If the weighted possibility is greater than a predetermined possibility, the determination module 402 may determine that the requester has consumed alcohol. If the weighted possibility is not greater than the predetermined possibility, the determination module 402 may determine that the requester has not consumed alcohol.

It should be noted that the above description of the process 700 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations in the process 700 may be omitted and/or one or more additional operations may be added to the process 700. For example, any one of operations 710 to 740 may be omitted as long as at least of one of operations 710 to 740 is performed to determine whether the requester has consumed alcohol. As another example, operation 750 may be omitted and only one of operations 710 to 740 may be performed to determine whether the requester has consumed alcohol.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for detecting drunk requesters in an Online to Offline (O2O) service platform, comprising:
a data exchange port communicatively connected to a network;
at least one non-transitory computer-readable storage medium including a set of instructions; and
at least one processor in communication with the data exchange port and the at least one non-transitory computer-readable storage medium, wherein when executing the set of instructions, the at least one processor is configured to direct the system to:
obtain information related to a request of an O2O service initiated by a requester via the data exchange port;
determine a probability that the requester has consumed alcohol using an alcohol consumption prediction model based on the information related to the request;
determine whether the probability that the requester has consumed alcohol is greater than a threshold;
in response to a determination that the probability that the requester has consumed alcohol is greater than the threshold, obtain information related to the requester;
determine whether the requester has consumed alcohol based on the information related to the requester; and
in response to a determination that the requester has consumed alcohol, transmit a notification that the requester has consumed alcohol to a provider terminal corresponding to the request of the O2O service via the data exchange port.

2. The system of claim 1, wherein the information related to the request includes at least one of a request time, a start location of the request, a location of the requester, an estimated distance between the start location of the request and the location of the requester, profile information of the requester, or historical feedback information with respect to the requester.

3. The system of claim 1, wherein the alcohol consumption prediction model is generated according to a model training process, the model training process including:
obtaining a plurality of historical orders;
obtaining a first set of historical orders with positive feedbacks from the plurality of historical orders;
obtaining a second set of historical orders with negative feedbacks from the plurality of historical orders;
obtaining a preliminary model; and
generating the alcohol consumption prediction model by training the preliminary model using the first set of historical orders with positive feedbacks and the second set of historical orders with negative feedbacks.

4. (canceled)

5. The system of claim 1, wherein to obtain information related to the requester, the at least one processor is further configured to direct the system to:
transmit a request to turn on a camera of a requester terminal associated with the requester via the data exchange port;
upon receiving an approval of the request from the requester, transmit a command via the data exchange port to the requester terminal to record at least one image or video; and
receive the at least one image or video from the requester terminal via the data exchange port.

6. The system of claim 1, wherein to obtain the information related to the requester, the at least one processor is further configured to direct the system to:
transmit a request to obtain an audio of the requester to at least one of a requester terminal or a provide terminal via the data exchange port, causing the at least one of the requester terminal or the provider terminal to activate the audio recording in the at least one of the requester terminal or the provider terminal; and
receive a recorded audio from the at least one of the requester terminal or the provider terminal via the data exchange port.

7. (canceled)

8. The system of claim 1, wherein to determine whether the requester has consumed alcohol based on the information related to the requester, the at least one processor is further configured to direct the system to perform at least one of:
analyzing acoustic properties of speech of the requester based on an audio or a video of the requester;
analyzing facial features of the requester based on an image or the video of the requester;
analyzing body movements of the requester based on behavior information related to the requester; or
analyzing physiological parameters of the requester based on physiological information of the requester.

9. The system of claim 8, wherein to analyze acoustic properties of speech of the requester, the at least one processor is further configured to direct the system to perform at least one of:
determining a voice rate based on the audio or the video of the requester;
determining a voice tone based on the audio or the video of the requester;
determining a number of pauses in the audio or the video of the requester;
obtaining one or more keywords from the audio or the video of the requester;
determining durations of sentences spoken by the requester in the audio or the video of the requester;
determining a frequency of misarticulations in the audio or the video of the requester;
determining a Linear Prediction Coefficient (LPC) based on the audio or the video of the requester; or
determining a Mel-scale Frequency Cepstral Coefficient (MFCC) based on the audio or the video of the requester.

10. The system of claim 8, wherein to analyze facial features of the requester based on an image or a video of the requester, the at least one processor is further configured to direct the system to perform at least one of:
determining colors of at least one of the face or the neck of the requester;
determining pupil sizes of the requester;
determining a blinking frequency of the requester;
determining a nodding frequency of the requester;
determining a yawning frequency of the requester; or
determining an eye closure duration of the requester.

11. The system of claim 8, wherein to analyze body movements of the requester based on behavior information related to the requester, the at least one processor is further configured to direct the system to perform at least one of:
determining whether the torso of the requester wobbles unsteadily; or
determining whether at least one leg of the requester wobbles unsteadily; or
determining whether at least one arm of the requester wobbles unsteadily.

12. The system of claim 8, wherein to analyze physiological parameters of the requester based on the physiological information of the requester, the at least one processor is further configured to direct the system to perform at least one of:
obtaining a blood sugar level of the requester based on the physiological information of the requester;
obtaining a blood pressure of the requester based on the physiological information of the requester;
obtaining a breathing rate of the requester based on the physiological information of the requester;
obtaining a body temperature of the requester based on the physiological information of the requester; or
obtaining a heart rate of the requester based on the physiological information of the requester.

13. A method implemented on a computing device having at least one processor, at least one computer-readable storage medium, and a communication platform connected to a network, comprising:
obtaining information related to a request of an Online to Offline (O2O) service initiated by a requester via a data exchange port;
determining a probability that the requester has consumed alcohol using an alcohol consumption prediction model based on the information related to the request;
determining whether the probability that the requester has consumed alcohol is greater than a threshold;
in response to a determination that the probability that the requester has consumed alcohol is greater than the threshold, obtaining information related to the requester;
determining whether the requester has consumed alcohol based on the information related to the requester; and
in response to a determination that the requester has consumed alcohol, transmitting a notification that the requester has consumed alcohol to a provider terminal corresponding to the request of the O2O service via the data exchange port.

14. (canceled)

15. The method of claim 13, wherein the alcohol consumption prediction model is generated according to a model training process, the model training process including:
obtaining a plurality of historical orders;
obtaining a first set of historical orders with positive feedbacks from the plurality of historical orders;
obtaining a second set of historical orders with negative feedbacks from the plurality of historical orders;
obtaining a preliminary model; and
generating the alcohol consumption prediction model by training the preliminary model using the first set of historical orders with positive feedbacks and the second set of historical orders with negative feedbacks.

16. (canceled)

17. The method of claim 13, wherein the obtaining information related to the requester comprises:
transmitting a request to turn on a camera of a requester terminal associated with the requester via the data exchange port;
upon receiving an approval of the request from the requester, transmitting a command via the data exchange port to the requester terminal to record at least one image or video; and
receiving the at least one image or video from the requester terminal via the data exchange port.

18. The method of claim 13, wherein the obtaining the information related to the requester comprises:
transmitting a request to obtain an audio of the requester to at least one of a requester terminal or a provide terminal via the data exchange port, causing the at least one of the requester terminal or the provider terminal to activate the audio recording in the at least one of the requester terminal or the provider terminal; and
receiving a recorded audio from the at least one of the requester terminal or the provider terminal via the data exchange port.

19. (canceled)

20. The method of claim 13, wherein the determining whether the requester has consumed alcohol based on the information related to the requester comprises:
analyzing acoustic properties of speech of the requester based on an audio or a video of the requester;
analyzing facial features of the requester based on an image or the video of the requester;
analyzing body movements of the requester based on behavior information related to the requester; or
analyzing physiological parameters of the requester based on physiological information of the requester.

21. The method of claim 20, wherein the analyzing acoustic properties of audio of the requester comprises:
determining a voice rate based on the audio or the video of the requester;
determining a voice tone based on the audio or the video of the requester;
determining a number of pauses in the audio or the video of the requester;
obtaining one or more keywords from the audio or the video of the requester;
determining durations of sentences spoken by the requester in the audio or the video of the requester;
determining a frequency of misarticulations in the audio or the video of the requester;
determining a Linear Prediction Coefficient (LPC) based on the audio or the video of the requester; or
determining a Mel-scale Frequency Cepstral Coefficient (MFCC) based on the audio or the video of the requester.

22. The method of claim 20, wherein the analyzing facial features of the requester based on an image or a video of the requester comprises:
determining colors of at least one of the face or the neck of the requester;
determining pupil sizes of the requester;
determining a blinking frequency of the requester;
determining a nodding frequency of the requester;
determining a yawning frequency of the requester; or
determining an eye closure duration of the requester.

23. The method of claim 20, wherein the analyzing body movements of the requester based on behavior information related to the requester comprises:
determining whether the torso of the requester wobbles unsteadily; or
determining whether at least one leg of the requester wobbles unsteadily; or
determining whether at least one arm of the requester wobbles unsteadily.

24. The method of claim 20, wherein the analyzing physiological parameters of the requester based on the physiological information of the requester comprises:
obtaining a blood sugar level of the requester based on the physiological information of the requester;
obtaining a blood pressure of the requester based on the physiological information of the requester;
obtaining a breathing rate of the requester based on the physiological information of the requester;
obtaining a body temperature of the requester based on the physiological information of the requester; or
obtaining a heart rate of the requester based on the physiological information of the requester.

25. A non-transitory computer-readable storage medium embodying a computer program product, the computer program product comprising instructions configured to cause a computing device to:
obtain information related to a request of an Online to Offline (O2O) service initiated by a requester via the data exchange port;
determine a probability that the requester has consumed alcohol using an alcohol consumption prediction model based on the information related to the request;
determine whether the probability that the requester has consumed alcohol is greater than a threshold;
in response to a determination that the probability that the requester has consumed alcohol is greater than the threshold, obtain information related to the requester;
determine whether the requester has consumed alcohol based on the information related to the requester; and
in response to a determination that the requester has consumed alcohol, transmit a notification that the requester has consumed alcohol to a provider terminal corresponding to the request of the O2O service via the data exchange port.
